(19) United States
(12) Patent Application Publication
(10) Pub. No.: US 2016/0003412 A1
(43) Pub. Date: Jan. 7, 2016

(54) SUSPENSION OF DEVICES FROM A SUPPORT

(71) Applicant: Domenick Francis DeRose, Carmel, NY (US)

(72) Inventor: Domenick Francis DeRose, Carmel, NY (US)

(21) Appl. No.: 14/810,550

(22) Filed: Jul. 28, 2015

Related U.S. Application Data
(63) Continuation-in-part of application No. 13/869,874, filed on Apr. 24, 2013, now abandoned.

(51) Int. Cl. F16M 13/02

(52) U.S. Cl. CPC F16M 13/027; F16M 13/022

(57) ABSTRACT

A method and structure are provided for suspending a slotted plate from a structural element such as an I-beam or a column. The slotted plate includes generally rectangular, preferably racetrack oval, slot holes on the two long sides of the plate surrounding an array of fields of diverse inner generally rectangular, preferably racetrack oval, slot holes in the middle of the plate arranged in wide and narrow columns and rows. The slot holes are arranged for fastening objects to the plate without drilling holes by using a method of sliding and/or rotating fixtures to be attached to the slotted plat until fixture mounting sites are aligned with the field of diverse inner slot holes. The slotted plate can be secured to an I-beam with an obliquely-sloped, arched clamp.

This application is a continuation-in-part application claiming the benefit of priority, under 35 U.S.C. Section 120, of U.S. patent application Ser. No. 13/869,874 entitled “Suspension of a Storage Framework from a Beam” that was filed on Apr. 24, 2013.

### BACKGROUND OF THE INVENTION

This invention relates to a method and a system for enabling overhead or lateral suspension of a slotted plate from an I-beam, a truss joist, a column, a post, and like supports, wherein a suspended slotted plate provides support to items such as illumination devices, cameras, loudspeakers and other devices.

As more and more materials including lawn chairs, sports equipment, recreational devices and the like accumulate in a space such as a garage, a problem is that there is insufficient space on the floor or on the walls for storage of such things in the space available. Accordingly there is a need for enhanced methods and equipment for providing supplemental storage space and suspension of ancillary equipment such as illumination devices, cameras, loudspeakers and other devices.

Heretofore storage systems suitable for suspension of fixtures from a beam have included open grid structures or platforms for planks. Such platforms require the burden of drilling holes for bolts and nuts for fastening items to the planks or open grid structures. Open grid structures are not designed for use of bolts and nuts as fasteners for suspension of fixtures therefrom without extensive modification.

In my parent application Ser. No. 13/869,874, filed on Apr. 24, 2013 and entitled “Suspension of a Storage Framework from a Beam” rectangular, slotted mounting plates are shown and described with wide, racetrack oval slots used for mounting the plates and an array of equally spaced small and narrow racetrack oval slots for other purposes.

Building codes prohibit drilling into structural elements such as beams, columns, truss joists and the like. Therefore there is a requirement for providing other means for supporting items from such structural elements without violation of building codes and to avoid accidents caused by damage to s structural elements.

While a slotted storage plate in accordance with the parent application for this invention has significant advantages, I have discovered that there are times when there is a problem with fastening fixtures to the uniformly sized and spaced array of slots in the slotted storage plate shown therein. In particular, in some cases it will be required to drill holes through such a slotted storage plate to prepare for mounting conventional objects with mismatching fastening sites onto such plates. The reason is that the matrix of equally spaced small slots does not always accommodate the locations of mounting bolts, screws and/or mounting holes of commercially available fixtures. In other words the devices to be attached to such a plate often have spacings which do not match the spacings of the uniformly spaced slot holes in the slotted storage plate.

Advantages of the present invention are that devices can be attached to the storage plate without drilling holes in the storage plate and without the cost of hiring professional installers.

Another advantage of the system and method of this invention is it avoids invasive changes to existing construction; and avoids a need for pre-construction.

Moreover, time is saved by avoiding clearing stored materials from a storage space such as a garage. Also, few tools and materials are required.

Another advantage of this invention is that an installation in a garage does not interfere with overhead garage door equipment and its operation or with the garage door.

In accordance with this invention overhead storage is provided in a structure with limited floor space for storage by suspending a framework from clamps secured to the flanges of a flanged overhead beam or attachment to a column.

One preferred form of flanged overhead beam is an “I” beam with a solid web, preferably composed of steel. A suitable alternative to such a steel I-beam is an OWTJ (Open Web Truss Joist) preferably made of steel having 4″ top and bottom flanges.

Typically, the steel OWTJ is used to support roof structures with series of opened half diamond steel rails welded to and in between the flanges forming a webbing structure that spans the length of the OWTJ. Regardless of the material of which the beam is composed the beam and the flanges must have sufficient strength to support the framework. In short, the invention provides for suspending a framework from flanges suitable for supporting a clamp, which flanges are formed on the sides of an I-beam or a truss joist.

As stated above, the present invention overcomes the problem of having insufficient floor space in structures that have overhead space.

The device enables the user to create overhead space easily by suspending a mechanical framework from a beam, e.g. an I-beam or a truss joist.

The invention provides a device which is easy to install, highly versatile and eliminates requisite steps, now being used to facilitate the creation of overhead storage more specifically, garages and other related garage framing configurations.

The process/system used today is restrictive due to impeding overhead garage doors, with the mechanical automatic door opening/closing devices and other fixed obstructions. In contrast, the system of the present invention enables creation of more overhead space below a support structure. and elsewhere in a space employing the storage system.

In a garage the system of this invention increases available storage space because the installation is not impeded by overhead garage doors, the devices associated with the door or the door itself. Thus additional storage space is created which had not been available heretofore.

An object of this invention is to provide a modular, slotted plate with slots arranged with spacing suitable for fastening objects with conventional spacings to the plate using the slots provided without drilling holes therefor.

### SUMMARY OF THE INVENTION

It is an object of this invention to provide a mounting plate adapted to be suspended from a support, which enables its user to mount items onto it neither having to drill a hole through the plate, nor to drill a hole through a support to which the mounting plate is to be attached.

It is a further object of this invention to provide a mounting plate with an incorporated pattern, which eliminates violating building codes, i.e. avoids drilling into structural elements such as beams, columns, truss joists and the like and avoids drilling holes in the mounting plate. In accordance with this invention overhead storage is provided in a structure with limited floor space for storage by suspending a framework from clamps secured to the flanges of a flanged overhead beam or a column.

It is another object of this invention to provide an improved arrangement of mounting slot holes in a mounting plate.

In accordance with this invention a slotted plate adapted there be suspended from a structural support is adapted for mounting objects thereon without drilling holes in he plate. The slotted plate is patterned with parallel slot fields referred to herein as fields. Each field comprises an array of parallel columns of racetrack oval slot holes with columns having different dimensions and orientations. Because of the pattern of racetrack oval slot holes through the slotted plate, the user can mount objects onto the slotted plate requiring neither drilling holes through the slotted plate, nor drilling of holes through the support to which the plate is to be attached. The plate with the incorporated pattern, provides the surface for and eliminates violating building codes, i.e. drilling into structural elements such as beams columns, truss joists and the like.

Further In accordance with this invention a suspension structure for suspending a slotted plate from a structural support comprises a slotted plate including a field with a plurality of columns of vertically oriented, stacked racetrack oval slots spaced apart horizontally, a column of horizontally oriented racetrack oval slots stacked vertically, and a clamp with fastening threaded fasteners extending through peripheral slots through the slotted plate for securing the slotted plate to the clamp to a structural support.

Preferably each vertically oriented racetrack oval slot is B=2A wide and 7A tall, the vertically oriented racetrack oval slots are spaced horizontally by width A, each of the horizontally oriented racetrack oval slots has a width of C=2A and a height of 7A, and the horizontally oriented racetrack oval slots are spaced vertically by space A.

It is further preferred that the suspension structure includes the clamp being fastened to the structural support, and the clamp being fastened to the slotted plate.

Preferably, the clamp comprises a recessed, end clamp foot, the end clamp foot including a horizontal, flat ball on the bottom, an obliquely-sloped bar reaching up at an oblique angle from a closed joint with the flat ball, the obliquely-sloped bar forming a joint on the top end of the oblique sloped bar with a flat ankle top which extends horizontally, an outer end of the end clamp foot being joined to an inner end of a segmented arch which has a flat top and an outer end ending in a heel, the segmented arch having a horizontal flat arch top parallel with the flat ankle top and the flat ball, and the bottom edge of the heel being coplanar with the flat ball.

Preferably, the clamp is fastened to the structural support, and the clamp is fastened to the slotted plate.

### BRIEF DESCRIPTION OF THE DRAWINGS

FIG. 1A is a fragmentary front perspective view of a rectangular, slotted mounting plate with peripheral mounting slots with an array of fields of generally rectangular, racetrack oval mounting slots.

FIG. 1B is a fragmentary rear perspective view of the rectangular, slotted, mounting plate FIG. 1A.

FIG. 1C is shows an enlarged fragmentary, front, perspective view of a portion of the rectangular, slotted, mounting plate of FIG. 1A illustrating a tilting mechanism therefor.

FIG. 2A is a front perspective view of the rectangular, slotted mounting plate of FIG. 1A.

FIG. 2B is a plan view of the rectangular, slotted mounting plate of FIG. 2A.

FIG. 2C is a detailed plan view of the rectangular, slotted, mounting plate of

FIG. 2B with generally rectangular, racetrack oval slot holes therethrough.

FIG. 2D is a fragmentary plan view including two fields of generally rectangular, racetrack oval slot holes through the rectangular, slotted, mounting plate of FIG. 2B.

FIG. 2E is a fragmentary plan view of the region of one field of the slotted plate of FIG. 2B with slots in the generally rectangular, racetrack oval slot holes through the rectangular, slotted, mounting plate arranged with spacing suitable for fastening objects to the plate. The generally rectangular, racetrack oval slot holes with conventional spacings are provided for fastening objects to the plate without drilling holes therethrough.

FIG. 2F is an enlarged plan view of FIG. 2E showing the region including the one field of the slotted plate of FIG. 2B and listing some of the dimensions of elements of one embodiment of the field.

FIG. 2G is a chart showing examples in inches of the dimensions of one embodiment of the field of a slotted plate as shown in FIG. 2F.

FIG. 2H is a flow chart describing the method of using a rectangular, slotted, mounting plate in accordance with this invention.

FIG. 2I is a chart showing more details in inches of the sizes and the dimensions of the spaces and the slots of one embodiment of the field of a rectangular, slotted mounting plate as shown in FIG. 2F.

FIG. 2J is a chart showing various screw sizes in inches and the dimensions of the spaces and the slots for the field of the rectangular, slotted mounting plate as shown in FIG. 2F.

FIG. 2K is a chart showing various screw sizes in millimeters and the matching slot dimensions for of the field shown in FIG. 2F.

FIG. 3 is fragmentary front perspective view of the rectangular, slotted mounting plate of FIG. 1A which has been modified by securing the plate to the flanges F of the beam with Z clamps.

FIG. 4 shows a rectangular, slotted mounting plate secured to a vertical pole by a strut and elongated screws. The angle of the plate may be tilted by adjusting knobs.

FIG. 5A shows a Z clamp with two holes for bolts FIG. 5A shows a Z clamp with two holes for bolts that secure the Z clamp to the flange of the beam as shown in FIGS. 1A, 1B and 3.

FIG. 5B shows a recessed, obliquely-sloped, end clamp.

FIG. 5C shows a recessed, left-oblique, sloped, connector clamp.

FIG. 5D shows a recessed, right-oblique, sloped, connector clamp.

FIG. 5E shows a right angle strut clamp with a threaded through hole for securing a strut when required.

FIG. 6 is fragmentary front perspective view of the rectangular, slotted, mounting plate of FIG. 1A connected by a recessed, obliquely-sloped, end clamp to a beam flange and to another slotted plate by means of a right connector clamp which is also secured to the beam flange.

FIG. 7 is fragmentary front, right perspective end view of the rectangular, slotted, mounting plate of FIG. 1A secured to both left and right lower flanges of the beam by a pair of recessed, obliquely-sloped, end clamps.

FIG. 8 is fragmentary front, left perspective end view of the repeating, modular, slotted plate of FIG. 1A secured to the lower left flange of the beam by a pair of recessed, obliquely-sloped, end clamps located in parallel on one side of the beam.

FIG. 9 is a perspective view which is a modification of FIG. 4 that shows two rectangular, slotted, mounting plates secured to a rectangular post.

FIG. 10A shows a plan view of a fixture for rotatably supporting rectangular, slotted, mounting plate.

FIG. 10B shows a elevational view of the fixture of FIG. 10A.

FIG. 11 is a fragmentary, perspective front, right end view of the rectangular, slotted, mounting plate of FIG. 1A secured to an open web truss joist beam by an end clamp. Set screws are set at their narrowest clearance between the plate and the underside of the beam. Clearances between plate 210 and the underside of the beam 212 are contingent on the thickness of the flange 212F. However, the clamps 500, accommodate a 1.125″ thick beam flange 212F with a minimum of 1.00″ clearance.

FIG. 12 is a fragmentary front, right perspective end view of a single repeating, modular, slotted plate 210 of FIG. 1A connected to double plats 210B and 210C. With the use of longer sized slotted channel, plates can be extended perpendicularly from one joist to another joist. This solution will facilitate larger and or multiple top and bottom plate mounts.

FIG. 13 is a perspective view of a framework in accordance with another embodiment of this invention in which two pairs of scissor arms of FIG. 1 are replaced by a pair of rectangular mounting plates with horizontal wide mounting slots and an array of narrow mounting slots and modified long bifurcated C-Clamps.

FIG. 14 is an enlarged, fragmentary perspective view of a long bifurcated C-Clamp of FIG. 13 secured to the left rim of an I-Beam and fastened to the upper left side of one of the mounting plates of FIG. 13.

### DETAILED DESCRIPTION OF THE INVENTION

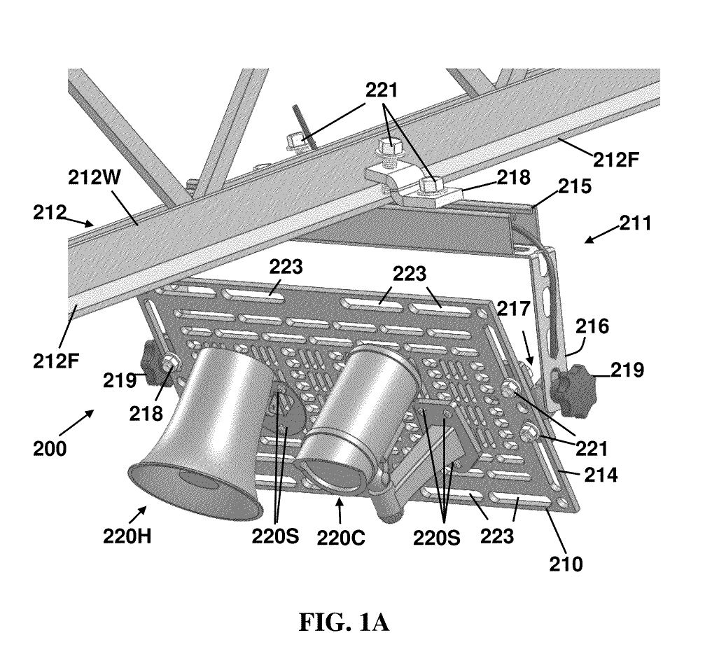

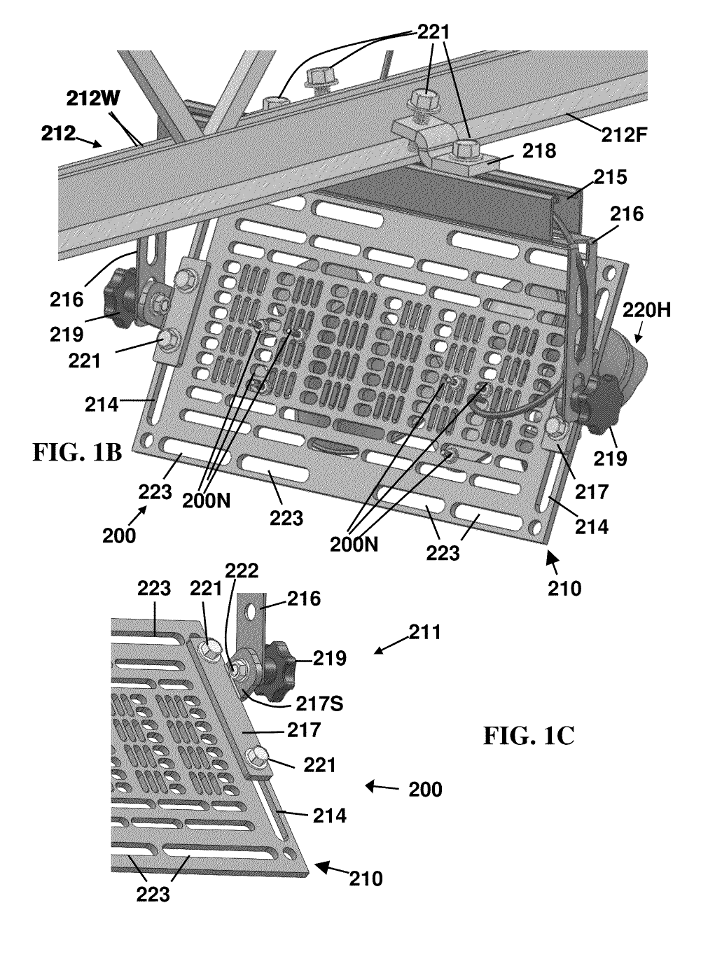

FIG. 1A is a fragmentary front perspective view of a repeating, modular, slotted plate 210 with an array of repeated fields of slot holes through the slotted plate 210 for providing connections for hardware such as cameras, lamps and loudspeakers.

The slot holes are of a generally rectangular, racetrack oval shape. On the periphery of plate 210 are interconnection racetrack oval slot holes 214 and 223 for support of the plate 210 as well as interconnection thereof with other modular, slotted plates as described in detail below.

The plate 210 is suspended from the beam flanges 212F of a beam 212 by a tiltable suspension structure 211. Beam 212 includes webs 212W. The plate 210 is secured to a bracket 217 shown in more detail in FIG. 1C to a strap 216, by a knob 219 rotatably secured to the bracket 217. The strap 216 is suspended by a slotted strut 215. The slotted strut 215 is secured by two Z clamps 221 (one shown in FIG. 1B) and bolts 221 to two beam flanges 212F (one shown in FIG. 1B) on opposite sides of the beam 212 as will be well understood by those skilled in the art.

The Z clamps 218 are slidable along the slot before the bolt 221 thereabove is tightened into a nut (not shown). A horn 220H and a camera 220C are fastened to the plate 210 by bolts fastened by screws 200S threaded through slot holes in plate 210 into nuts 200N shown on the back of plate 210 in FIG. 1B. Loosening of the bolts 221 on the flanges 212F and the bolts secured to the slotted strut 215 permits rapid sliding of the Z clamps 218 away from the beam 212 permitting rapid adjustment of position or removal of the plate from the beam 212.

FIG. 1B is a fragmentary rear perspective view plate 210 of FIG. 1A with fields of slot holes showing the threaded nuts 222 securing horn 220H and a camera 220C to the plate 210. The other beam flange 212F and the other Z clamp 218 are shown on the opposite side of the beam 212.

FIG. 1C is a fragmentary, front perspective view of a portion of FIG. 1A showing an enlarged view of the a tiltable suspension structure 211 for suspending the plate 210 from the beam 212 of FIG. 1A.

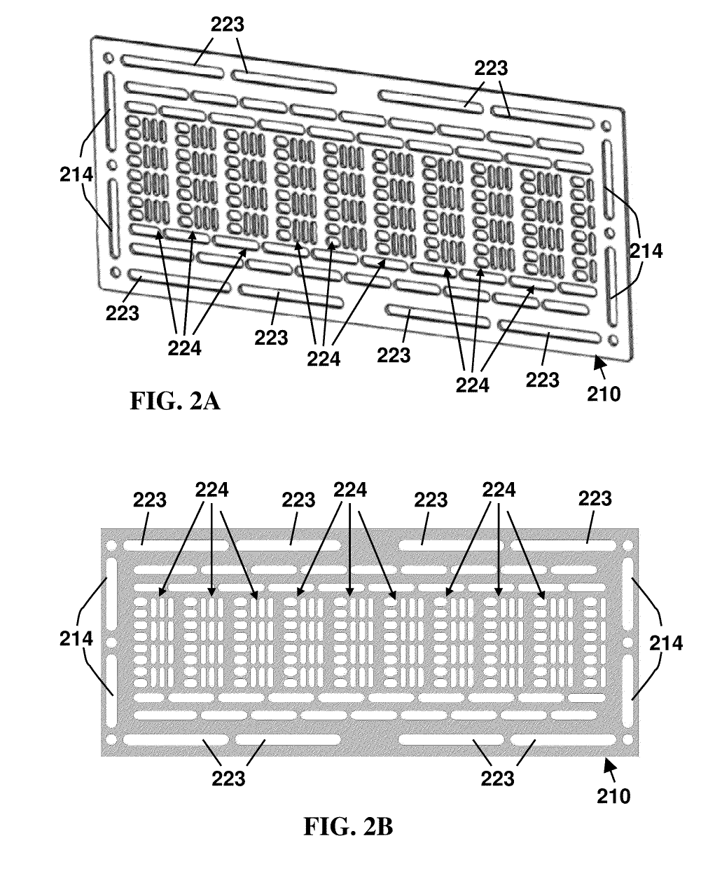

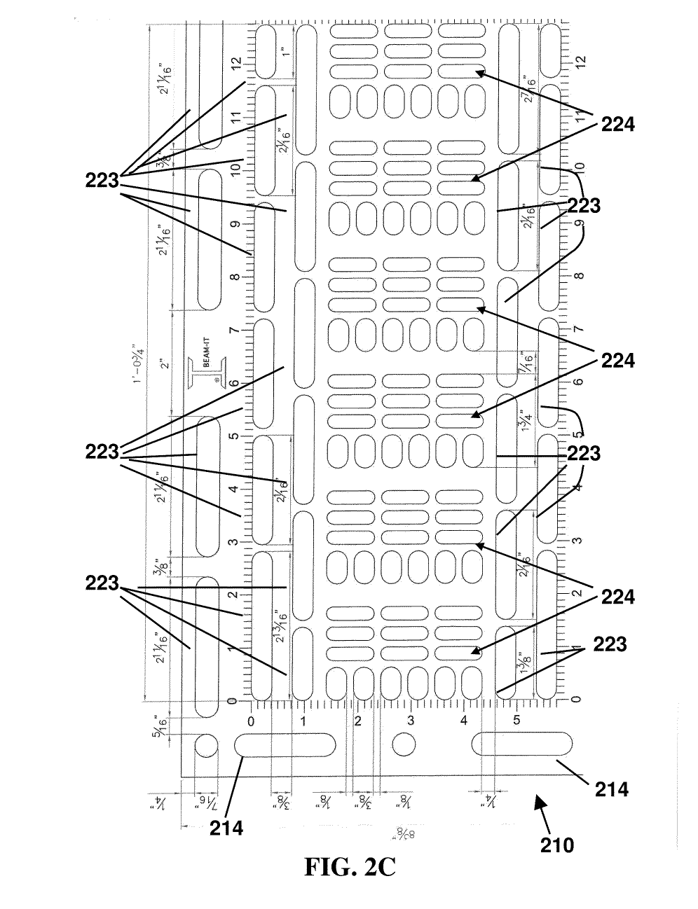

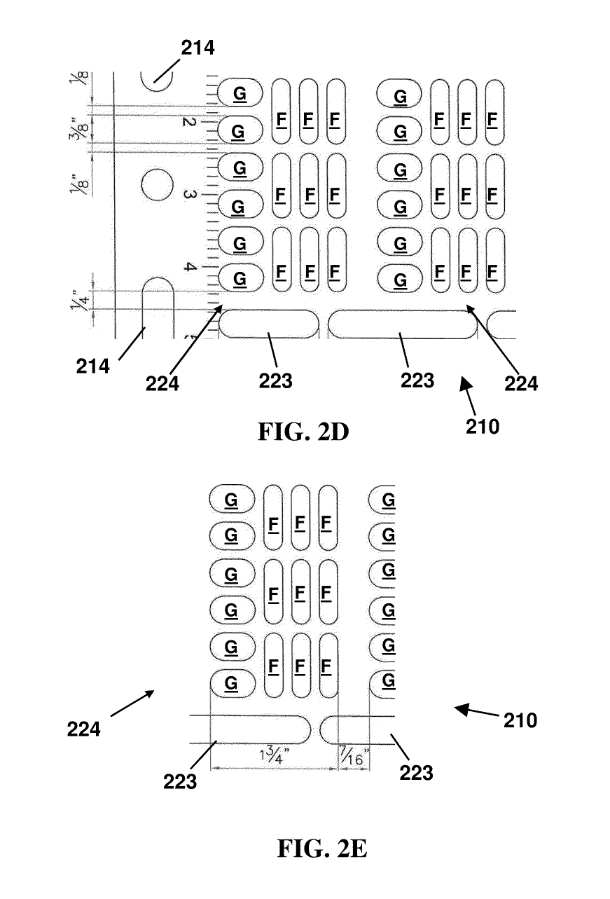

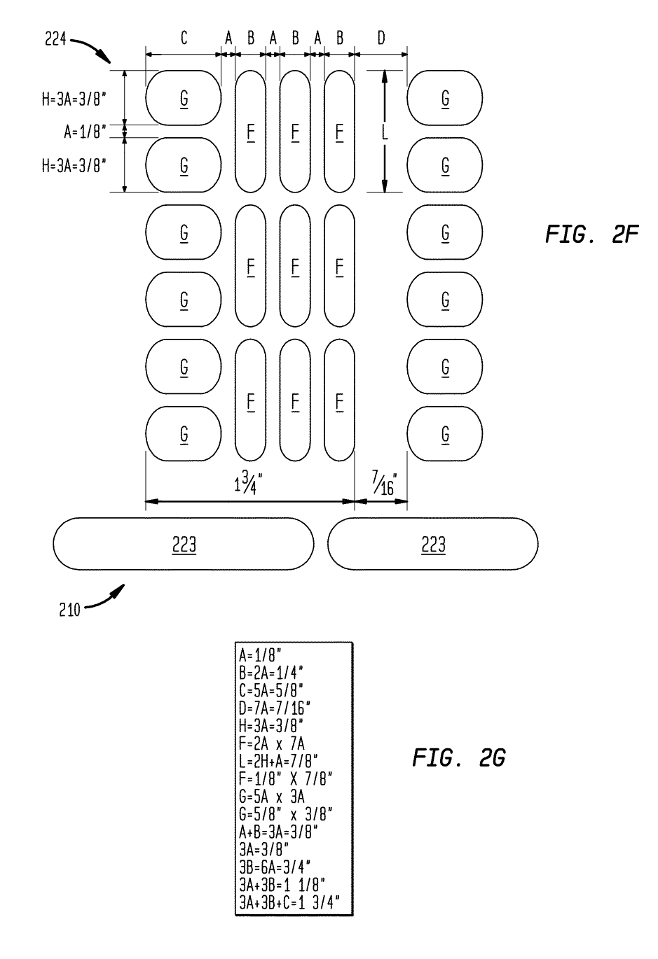

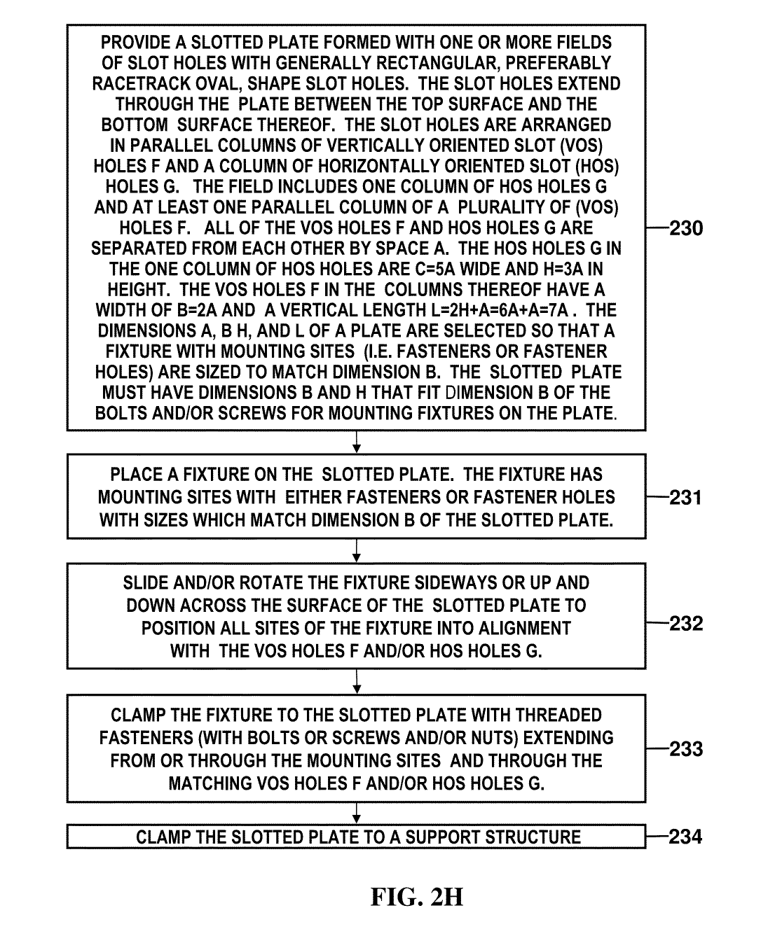

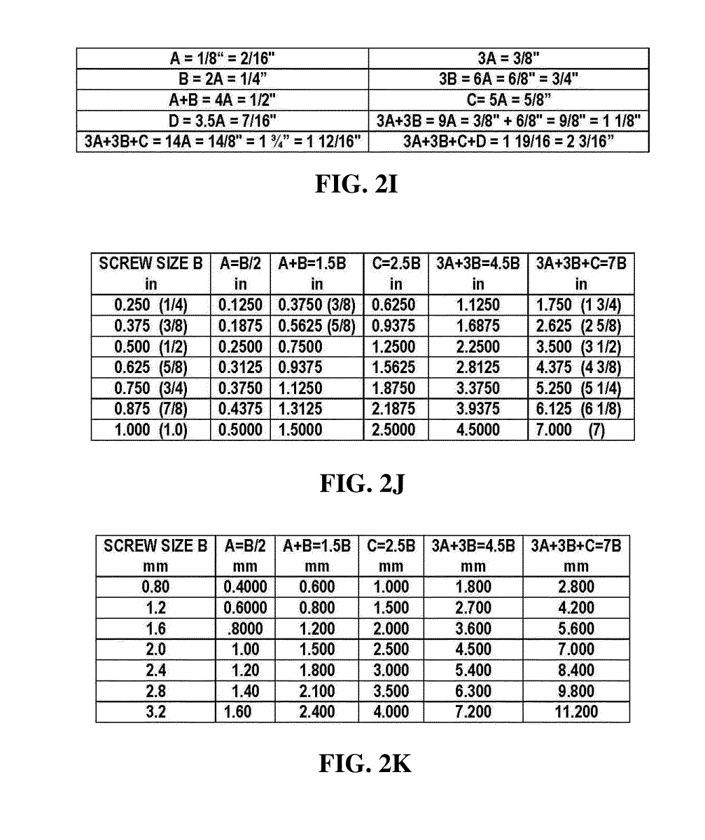

FIG. 2A is a front perspective view of the slotted plate of FIG. 1A showing peripheral slot holes 214 and 223 and a parallel array of fields 224 of generally rectangular, preferably racetrack oval, slot holes. A field 224 is shown in more detail in FIGS. 2D and 2E. The field 224 includes narrow, slot holes F and wide slot holes G.

FIG. 2B is a plan view of the plate 210 of FIG. 2A showing peripheral generally rectangular, preferably racetrack oval slot holes 214 and 223 and the parallel array of fields 224 of generally rectangular, preferably racetrack oval shaped slot holes.

FIG. 2C is a detailed plan view of the slotted plate 210 of FIG. 2B with generally rectangular, outer racetrack oval slot holes 214 on the bottom end of the plate 210, and outer generally rectangular, preferably racetrack oval, slot holes 223 on the two long sides of the plate 210 surrounding an array of six fields 224 of smaller generally rectangular, racetrack oval mounting slot holes F and G in the middle of the plate 210 as shown in more detail in FIGS. 2D-2F.

FIG. 2D is a fragmentary plan view of the plate 210 of FIG. 2B showing two fields 224 of the generally rectangular, preferably racetrack oval mounting narrow, slot holes F and the wide slot holes G above the racetrack oval slot holes 223 on the border of the modular, slotted plate 210. The slot holes F and G are provided for fastening objects to the plate 210 without drilling holes therethrough by employing the method described in detail with reference to FIG. 2H.

FIG. 2E is a fragmentary plan view of the plate 210 of FIG. 2D showing a region including one field 224 of the slotted plate 210 of FIG. 2B separated from a column of wide slot holes G by 7/16″ which is an example of spacing for a plate 210 of one exemplary scale. That is the scale for holes F of ¼″ is illustrative of the nominal size required for accommodating bolts and/or screws with nominal ¼″ sizes.

FIG. 2F is an enlarged plan view of the of the plate 210 of FIGS. 2D and 2E showing a region including the one complete field 224 and a fragmentary portion of a second column of wide slot holes G comprising a portion of a second field 224. FIG. 2F shows some illustrative dimensions of elements of one embodiment of the field 224. FIG. 2F shows details of one of the repeating slot pattern fields 224 in the slotted support plate 210. The field 224 includes a vertical column of six, generally rectangular, racetrack oval, wide slot holes G which are C=5A=⅝″ wide of H=3A=⅜″ tall with vertical spaces A=⅛″ therebetween and which are oriented horizontally. In addition the field 224 includes nine, generally rectangular, racetrack oval, narrow slot holes F are B=2A=¼″ wide and 2H+A=7A=7⅜″ tall. The narrow slot holes F are located in rows parallel to the single column of wide slot holes G and which are oriented vertically and which are separated by spacing dimension A. The generally rectangular, racetrack oval slot holes F and G are separated by spacing dimension A are provided for fastening objects to the plate 210 without drilling holes therethrough. Note that each row of narrow slot holes F is L=⅞″ tall which is total of the height of two wide slot holes G (⅜″+⅜″) plus the space (A=⅛″) therebetween.

In FIG. 2F, the nine narrow slot holes F are arranged in three vertical columns with each of those three vertical columns comprising three of the narrow slot holes F. Each vertical column includes three of the nine narrow slot holes F. Each vertical column includes three narrow slot holes F, each of which is parallel to a pair of the wide slot holes G in the left column of the field 234. Also, the field 224 is shown bordered by two outer racetrack oval slot holes 223.

It should be noted that the examples shown in FIGS. 2E and 2F are illustrative in terms of the number of rows of slot holes F and G which may be modified from the six rows of the wide slots G and the three rows of the narrow slot holes F. That is to say that the array of slot holes in the field can be shortened or lengthened vertically so that, for example there might be pairs of two, three, four, five, or six wide slot holes G in the left column matched with three columns containing three, six, nine, or twelve narrow slot holes F, with three columns of nine narrow slot holes F shown in FIGS. 2E and 2F.

In FIG. 2F each of the six racetrack oval wide slot holes G is C=5A=⅝″ wide and H=3A=⅜″ tall with vertical spaces A=⅛″ between the wide slot holes G. Each of the narrow slot holes F is B=2A=¼″ wide and is L=2H+A=⅞″ tall with horizontal spaces A=⅛″ therebetween. The four vertical columns contain one column of wide slot holes G and three columns of narrow, slot holes F all of which are spaced apart horizontally by A=⅛″. The column of six wide racetrack oval, slot holes G are spaced apart vertically by spaces A=⅛″. At the top of FIG. 2F indicia C, A, B, A, B, A, B, and D indicate the dimensions listed in the table shown in FIG. 2G on the left of FIG. 2F.

FIG. 2G is a chart showing examples in inches of the dimensions A, B, C, and D for the array of slot holes E and G and spacings A and D between for this particular illustrative embodiment of the field 224 as shown in FIG. 2F of a plate 210. The dimensions A, B, C, and D indicate the horizontal dimensions of the racetrack ovals G and F and the dimensions A and D indicate the between racetrack ovals G and F for this particular illustrative embodiment of the support plate 210. On the left side of FIG. 2F are indicia 3A and A indicate vertical dimensions of the racetrack ovals G and F and spacings therebetween for this particular illustrative embodiment of the support plate 210 as listed in the table shown in FIG. 2G.

FIG. 2H is a flow chart describing the method of using a slotted plate 210 in accordance with this invention to support one or more fixtures 220C and/or 220H.

In step 230, provide a slotted plate 210 formed with one or more fields of generally rectangular, preferably racetrack oval, shape slot holes F and G. The slot holes extend through the plate between the top surface and the bottom surface thereof. The slot holes are arranged In parallel columns of vertically oriented slot (VOS) holes F and horizontally oriented slot (HOS) holes G. The field includes one column of HOS holes G and at least one parallel column of a plurality of (VOS) holes F. All of the VOS holes F and the HOS holes G are separated from each other by space A. The HOS holes G in the one column of HOS holes G are B=5A wide and H=3A tall. The VOS holes F are B=2A wide and are L=2H+A=6A+A=7A tall. The dimensions A, B H, and L of a plate are selected so that a fixture with mounting sites (i.e. fasteners or fastener holes) are sized to match dimension B. The slotted plate must have dimensions B and H that fit dimension B of the bolts and/or screws for mounting fixtures on the plate.

In step 231, place a fixture(s) 220C and/or 220H on the slotted plate 210. The fixture(s) 220C and/or 220H has mounting sites with either fasteners or fastener holes with sizes which match dimension B of the slotted plate 210.

In step 232, slide and/or rotate the fixture(s) 220C and/or 220H sideways or up and down across the surface of the slotted plate 210 to position all of the mounting sites of the fixture(s) 220C and/or 220H in to alignment with the VOS holes F and/or HOS holes G in the slotted plate 210.

In step 233, clamp the fixture(s) 220C and/or 220H to the slotted plate 210 by bolting the fixture(s) 220C and/or 220H to the slotted plate 210 with threaded fasteners extending from or through the mounting sites and through the matching VOS holes F and/or HOS holes G at all of the mounting sites of the fixture(s) 220C and/or 220H.

Clamp the slotted plate 210 to a support structure 212/400 with clamps 500/415.

As shown in FIG. 2F, the generally rectangular OS holes in the one column of the HOS holes G are B=5A wide and H=3A in height. The generally rectangular holes in the columns of VOS holes F have a width of B=2A and a vertical length L=2H+A=6A+A=7A. The slotted plate is selected so that a fixture with mounting sites (i.e. fasteners or fastener holes) are sized to match dimension B dimensions A, B H, and I of the fixtures to be mounted thereon which may vary considerably depending upon the scale and weight of the fixtures to be employed. The dimensions A, B H, and I of a plate are selected so that a fixture with mounting sites (i.e. fasteners or fastener holes) are sized to match dimension B. Thus select the dimensions of a slotted plate 210 with suitably sized dimensions B and H that match the dimension B of screws and/or bolts matched to the of the mounting sites of fixtures to be mounted thereon.

FIG. 2I shows sizes and dimensions of the spaces and the slot holes of the embodiment of a field of the plate 210 in FIG. 2F in the chart as follows: A=⅛″, 3A=⅜″, B=2A=¼″, 3B=6A=¾″, A+B=3A=⅜″, C=5A=⅝″, D=3.5A= 7/16″, 3A+3B=9A=⅜″+ 6/9″= 9/8″=1⅛″, 3A+3B+C=14A= 14/8″=1¾″, and 3A+3B+C+D=1 19/16″=2 3/16″. It should be noted that the dimensions cited above may be adjusted to accommodate for the fact that screw dimensions vary from time to time from nominal dimensions.

FIG. 2J is a chart showing various screw sizes in inches and the dimensions of the spaces A and the dimensions B and C of the racetrack oval slot holes F for the field 224 of a plate 210 as shown in FIG. 2F.

FIG. 2K is a chart showing various screw sizes in millimeters and the matching slot dimensions the spaces A and the dimensions B and C for of the field 224 of a plate 210 shown in FIG. 2F.

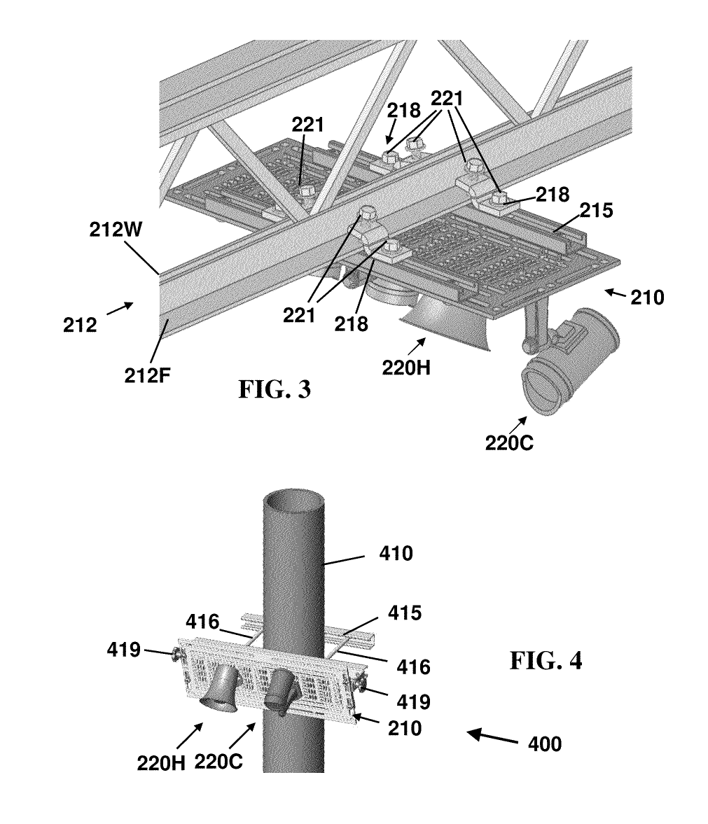

FIG. 3 is fragmentary front perspective view of the plate 210 of FIG. 1A (below a the beam 212) with the modification that the plate 210 is secured to the beam flanges 212F directly with four Z clamps 218 with two thereof on each side of the web 212W of the beam 212 on front and back edges of the plate 212. Loosening the bolts 221 on the beam flanges 212F and the bolts 221 secured to the slotted strut 215 permits rapid sliding of the Z clamps 218 away from the beam 212 thereby permitting rapid removal of the plate 210 from the beam 212.

FIG. 4 is a perspective view 400 which shows a repeating, modular, slotted plate 210 secured to a vertical pole 410 by a strut 415 and elongated screws 416 on the opposite side of the pole 410. The angle of the plate 210 may be tilted by adjusting knobs 419 to rotate the angle of the plate 210 from vertical.

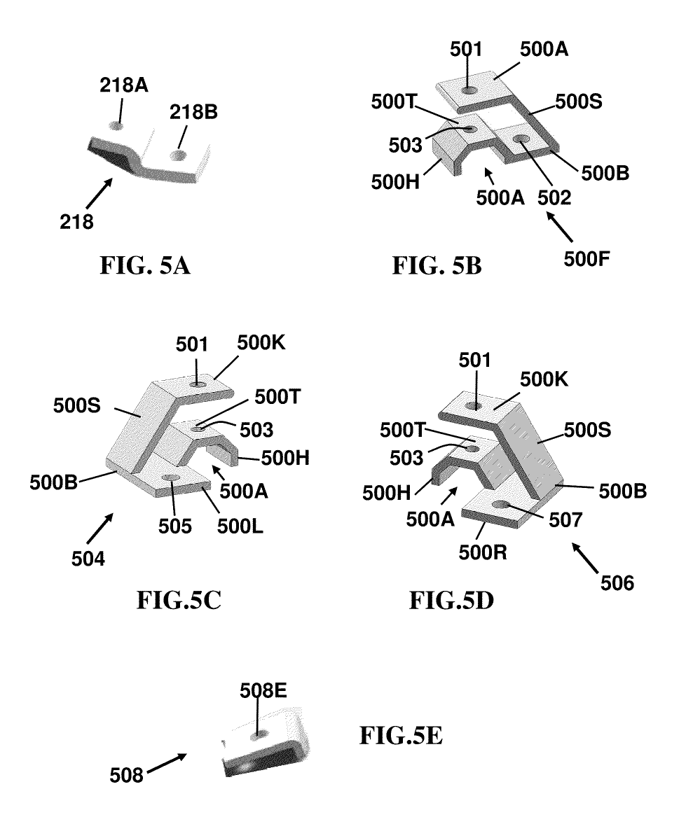

FIG. 5A shows a Z clamp 218 with two holes 218A and 218B for bolts 221 of FIG. 3 that secure the Z clamp to a beam flange 212F. The Z clamps 218 and bolts 221 are shown securing the slotted strut 215 to the beam flange 212F in FIGS. 1A, 1B and 3.

FIG. 5B shows a recessed, obliquely-sloped, end clamp foot 500F. End clamp foot 500F includes a horizontal, flat ball 500B of the end clamp foot 500F on the bottom, an oblique sloped bar 500S reaching up at an oblique angle from a closed joint of the flat ball 500B to a joint with a flat ankle top 500K (which extends horizontally) formed on the top end of the oblique sloped bar 500S. That is to say that the oblique sloped bar 500S extends at an oblique angle to connect the closed joint of the horizontal, flat ball 500B of end clamp foot 500F reaching up to the joint of the flat ankle top 500K.

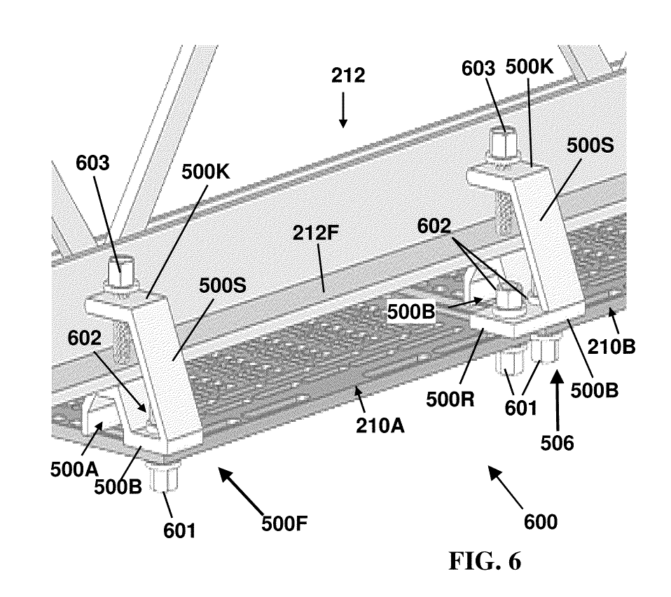

In addition to the horizontal ball 500B connected to the lower end of the oblique sloped bar 500S, an outer end of the end clamp foot 500F is joined to an inner end of a segmented arch 500A which has a flat top 500T and an outer end comprising a heel 500H. That is to say that segmented arch 500A has a horizontal flat top 500T (parallel with the ankle top 500K) and an outer end which is the heel 500H of the arch 500A. The flat top 500T extends parallel to the flat ankle top 500K as well as the flat ball 500B. The bottom edge of the heel 500H is coplanar with the flat ball 500B. The ball flat includes a threaded through hole 502. The flat ankle top 500K includes a threaded through hole 501. Directly below the flat ankle top 500K is the segmented arch 500A with a threaded through hole 503, which is directly aligned with and above the threaded through hole 501 in the flat ankle top 500K. The end clamp foot 500F is employed to secure a repeating, modular, slotted plate 210 to a beam flange 210F as shown in FIGS. 6, 7, 8, and 11.

FIG. 5C shows a recessed, oblique, sloped, left connector clamp 504. Connector clamp 504 is the similar to end clamp foot 500F except that it includes a left extension 500L from the bottom section with a threaded through hole 505, and the flat ball 500B does not include a threaded through hole 502. The clamp 504 is employed to secure a slotted plate 210 to another slotted plate, as shown and described below with reference to FIG. 12. Referring to FIG. 5A, etc., like parts identified by like indicia described above have the same function.

FIG. 5D shows a recessed, oblique, sloped, right connector clamp 506. The right connector clamp 506 is similar to end clamp foot 500F except that it includes a right extension 500R from the bottom section with a threaded through hole 505, and the bottom section does not include a threaded through hole 502. The clamp 504 is employed to secure the slotted plate and 210 to another slotted plate, as shown in FIG. 6. Referring to FIG. 5A etc., like parts identified by like indicia described above have the same function.

FIG. 5E shows a right angle strut clamp 508 with a threaded through hole 508E for securing a strut when required.

FIG. 6 is fragmentary front perspective view of a repeating, modular, slotted plate 210A of the type shown in FIG. 1A. The lower left end of plate 210A is connected by a recessed, obliquely-sloped, end clamp foot 500F and a bolt 601 extending through threaded hole 602 (shown in FIG. 5B) and a slot through plate 210A into a nut 602. The upper surface of arch 500A is in contact with the lower surface of the beam flange 212F. A bolt 603 is shown extending through threaded hole 501 (shown in FIG. 5B) onto the top surface of beam flange 212F clamping the end clamp 500F the beam 212.

Referring again to FIG. 6 another slotted plate 210B is secured to the beam 212 by means of a right connector clamp 506 which is also secured to the beam flange 212F. The end clamp foot 500F and the right connector clamp 506 are secured respectively to the plates 210A and 210B by bolts 601 and nuts. Like part numbers in FIGS. 5B and 5D refer to like parts described above.

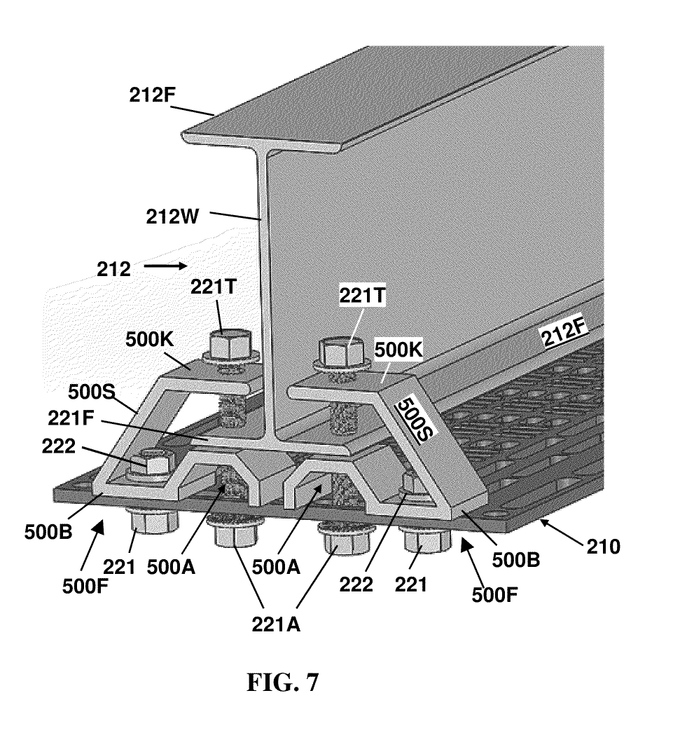

FIG. 7 is fragmentary front, right perspective end view of the modular, slotted plate 210 of FIG. 1A secured to both left and right lower beam flanges 212F of beam 212 by a pair of end clamp feet 500F of FIG. 5B. Like elements described above are described above with reference to FIG. 5B. Bolts 221A extend through slot holes through the plate 210 and through the holes 503 in the arches 500A of end clamp feet 500F and are screwed therethrough to contact the lower surfaces of the beam flanges 212F of the beam 212. Bolts 221 extend through slot holes through the plate 210 and through the holes 502 in the flat balls 500B of end clamp feet 500F which are affixed thereby to the top surface of plate 210 on opposite sides of the beam 212. The bolts 221T are screwed down through the through threaded hole 501 in the flat ankle top 500K onto the top surfaces of beam flanges 221 F. Screws 221A are screwed up through threaded holes 503 in the tops 500T of the end clamp feet 500F and onto the lower surfaces of beam flanges 212F. Thus flanges 221F are gripped between bolts 221 on the bottom and bolts 221T on the top of the beam flanges 212F.

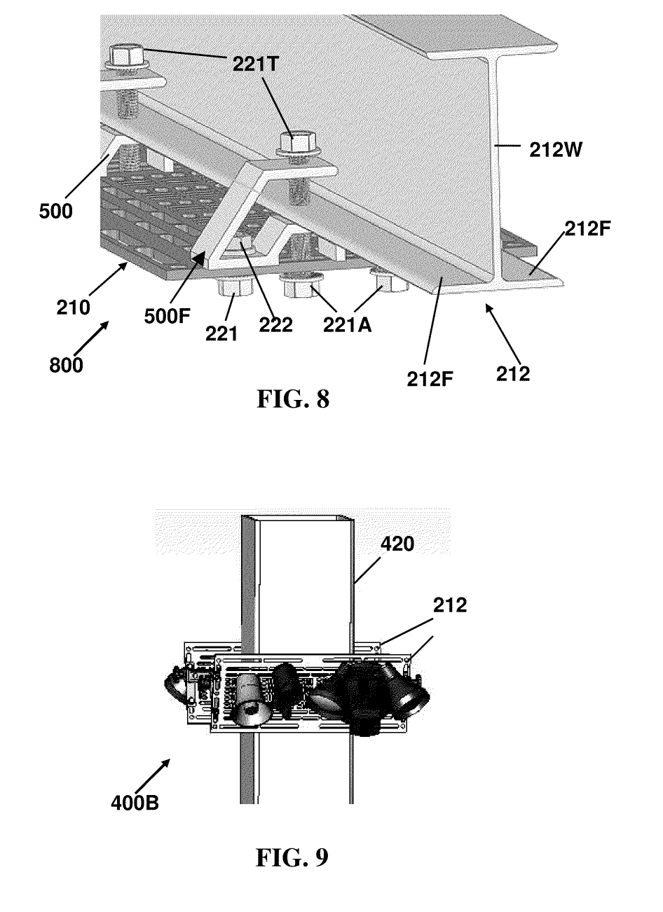

FIG. 8 is a modification of FIG. 7 showing a fragmentary front, left perspective end view of the modular, slotted plate 210 of FIG. 1A secured to a lower left beam flange 212F of beam 212 by a pair of recessed, obliquely-sloped, end clamps 500f and bolts 221, 221A and 221T. Two of four end clamp feet 500F are shown located in parallel on the left side of the beam 212. The other two clamp feet 500F, behind the web 212F of beam 212 are not visible. The other details are the same as described with reference to FIG. 7.

FIG. 9 is a perspective view 400B which is a modification of FIG. 4 showing two of the modular, slotted plates 210 secured to a rectangular post 420.

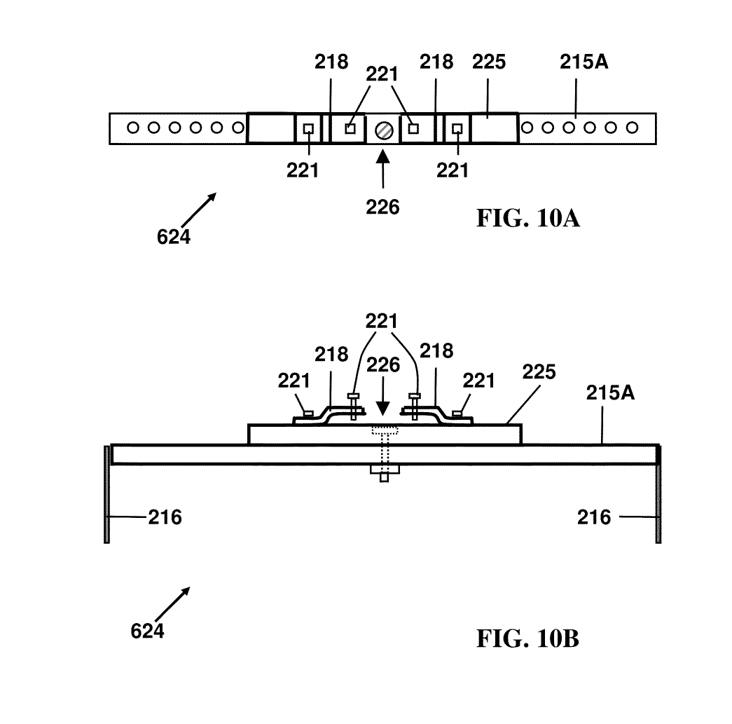

FIG. 10A is a sketch of a plan view of a fixture 624 for rotatably supporting a slotted plate 210 about a vertical axis. Two Z clamps 218 (shown in FIG. 5A) are secured by bolts 221 to a shorter length of round hole stock support 225. The two Z clamps 218 are fastened to support 225 with two threaded holes therethrough for bolts 221. The Z clamps 218 are provided to secure the support to flanges of a beam. Then a longer round hole stock support 215A is suspended by a pivot 226 for rotatational support of a slotted plate 210 as shown in FIGS. 1A, 1B and 3. Thus the fixture adapted to rotate the position of the plate 210 about the vertical axis of the pivot 226.

FIG. 10B shows a elevational view of the fixture 624 of FIG. 10A. Straps 216 are suspended from the ends of support 215A for fastening to a plate 210 as shown in FIGS. 1A and 1B.

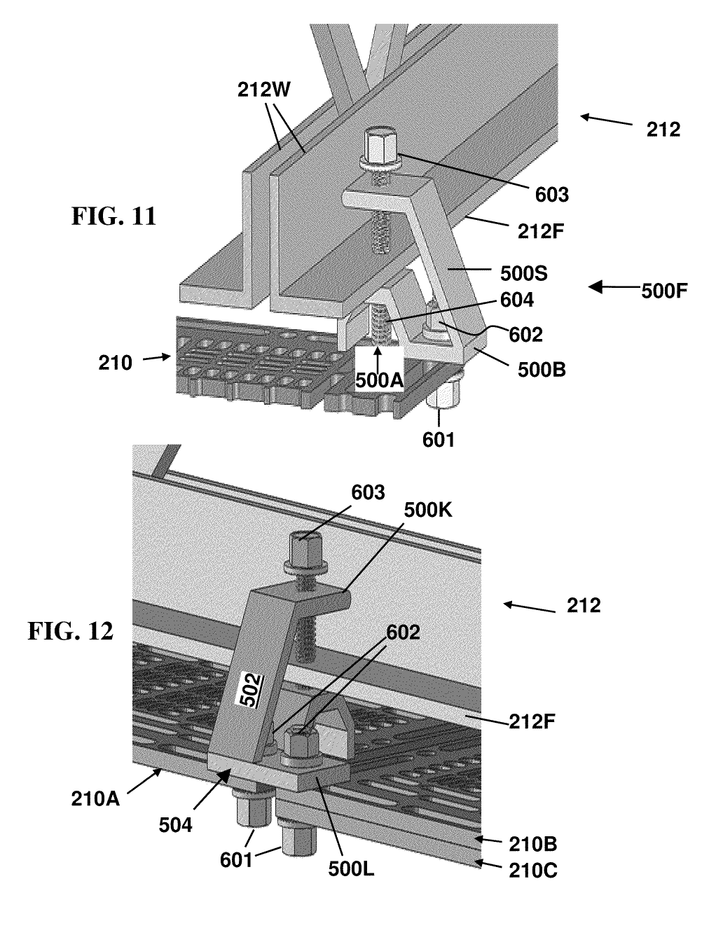

FIG. 11 is a fragmentary front, right perspective end view of the repeating, modular, slotted plate 210 of FIG. 1A secured by bolt 601 and nut 602 to an end clamp 500F which is fastened to a beam flange 212F of an open web truss joist beam 212. Set screw 604 which contacts the lower surface of the beam flange 212F is set at the narrowest clearance between the plate 210 and the underside of the beam 212. Set screw 603 is screwed down into contact with the upper surface of the beam flange 212F so set screws 603 and 604 fasten the end clamp 500F to the flange 212F. Clearances between plate 210 and the underside of the beam 212 are contingent on the thickness of the beam flange 212F. But, clamps 500, accommodate a 1.125″ thick beam flange 212F with a minimum of 1.00″ clearance.

FIG. 12 is a fragmentary front, right perspective end view of a single modular, slotted plate 210 of FIG. 1A suspended by a left connector clamp 504 from the flange 212F of an open web truss joist beam 212 and connected to stacked plates 210B and 210C doubling the thickness thereof by a bolt 601 extending through a hole (not shown) and screwed tightly through a nut 602 as described above with reference to FIG. 6. With the use of longer sized slotted channel, plates 210, 210B and 210C can be extended perpendicularly from one joist to another joist 212. This solution will facilitate larger and or multiple top and bottom plate mounts. The left connector clamp 504 is secured to the flange 212F by set screw 603 and set screws 603 not shown threaded through the threaded hole 505 in the arch of clamp 504 shown in FIG. 5C.

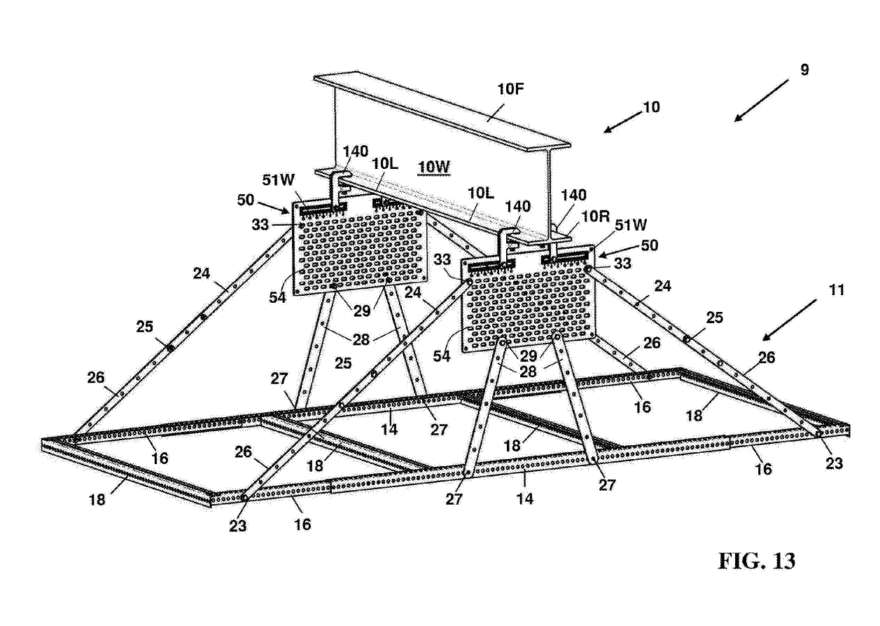

FIG. 13 is a perspective view of a framework 9 in accordance with an embodiment of this invention including a pair of rectangular mounting plates 50 with horizontal wide mounting slot holes 51W therethrough and an array of narrow mounting slot holes 54 and modified long C-Clamps 140.

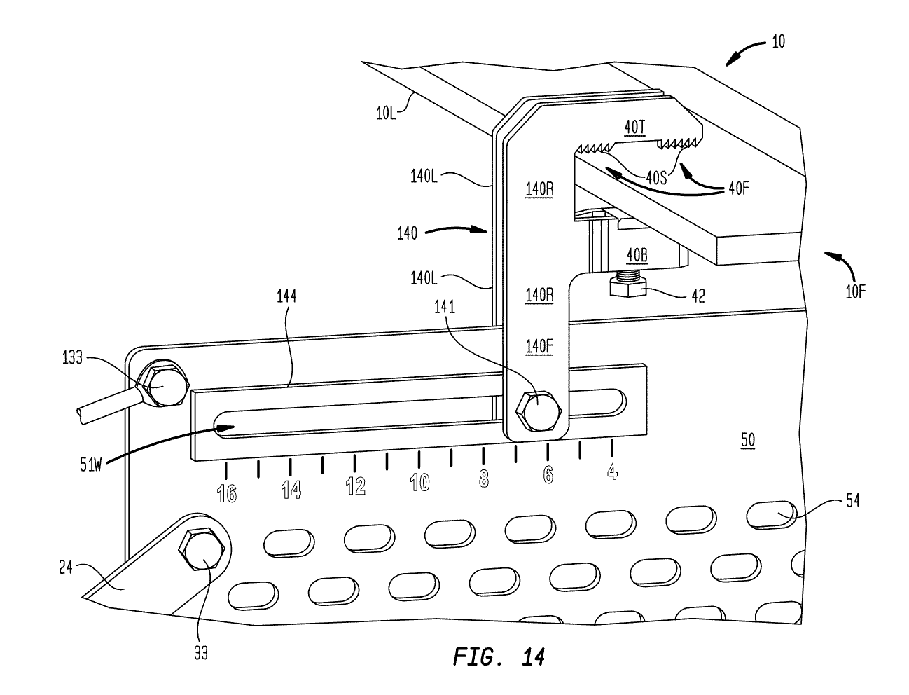

FIG. 14 is an enlarged, fragmentary perspective view of a long C-Clamp 40 of FIG. 13 secured to the left rim 10L of the I-Beam 10 and fastened to the upper left side of one of the mounting plates 50 of FIG. 13.

Referring to FIG. 14, the long, bifurcated C-Clamps 140 long left and right frames 140L and 140R. A foot 140F extends from the bottom of the left and right frames 140L and 140R. Each mounting plate 50 is inserted at the feet 140F between frames 140L and 140R of each C-Clamp 140 and mounted to those frames by fasteners 141, which may be bolts and nuts, pass through the holes 141 H (shown in FIGS. 16A-16C), through frames 140L and 140R at the feet 140F of the long C-Clamps 140 as well as through the two wide mounting slots 51W along the wide side of the mounting plate 50.

As shown in FIG. 14, the top edge of the mounting plate 50 is sandwiched, between the feet 140F of the frames 140L and 140R of the bifurcated C-Clamps 140. The bifurcated C-Clamps 140 include a left frame 140L and a right frame 140R. In FIGS. 13-15 the mounting plate 50 and the two mounting slots 51W are horizontally oriented, although the mounting plate can be employed with various features and orientation as described below with respect to other embodiments. It should be noted that the mounting plate 50 is shown in FIGS. 14 and 15 to have the wide mounting slots 51W formed therethrough with peripheral anti-rotation interlock surfaces 144 surrounding the slots 51W as well as indicia marking the location of the C-Clamps 140 in the slots 51W.

In FIG. 13, the legs 28 and the upper diagonal braces 24 are fastened to the mounting plate 50. As described above, the lower diagonal braces 26 are fastened to each one of the upper diagonal braces 24 by bolts 25 and nuts with anti-rotation interlocks 44 provided to hold the lower diagonal braces 26 in alignment with the upper diagonal braces 24 after tightening of the bolts 33 and the associated nuts. In addition, the shelf support frame 11 is secured to the lower diagonal braces 26 and to the legs 28. In particular, each of the two main rails 14 on the left or the right is suspended respectively from one of the legs 28 on the left or the right of the I-Beam 10. Each main rail 14 is fastened to legs 28 by the fasteners 27. Each extension rail 16 is suspended from lower diagonal braces 26 on the left and the right respectively and fastened thereto by fasteners 23.

The bifurcated C-Clamps 140 include a left frame 140L and a right frame 140R. Each frame 140L/140R includes a pair of jaws including a bottom jaw 40B and a top jaw 40T confronting each other. The top jaw 40T of both frames 40L/40R includes parallel clamping faces 40F. The lower jaw 40B carries a fastener 42 comprising a threaded pressure screw 42 that engages a lower surface of the left rim 10L of a beam flange 10F of an I-beam 10. The faces 40F of the top jaw 40T are formed with downwardly directed serrated teeth 40S. A threaded bore hole through the bottom jaws 40B houses a pressure screw 42 shown in FIGS. 13 and 14 which is tightened to affix the clamp 140 to the rim 10L or 10R of the beam flange 10F of I-beam 10

The foregoing description discloses only exemplary embodiments of the invention. Modifications of the above disclosed apparatus and methods which fall within the scope of the invention will be readily apparent to those of ordinary skill in the art. While this invention is described in terms of the above specific exemplary embodiment(s), those skilled in the art will recognize that the invention can be practiced with modifications within the spirit and scope of the appended claims, i.e. changes can be made in form and detail, without departing from the spirit and scope of the invention. Accordingly, while the present invention is disclosed in connection with exemplary embodiments thereof, it should be understood that changes can be made to provide other embodiments which may fall within the spirit and scope of the invention and all such changes come within the purview of the present invention and the invention encompasses the subject matter defined by the following claims

What is claimed is:

1. A method of suspending fixtures from a support structure comprising:
a) providing a slotted plate formed with slot holes extending through the plate between the top surface and the bottom surface thereof wherein as follows:
the slot holes being arranged In parallel columns of vertically oriented slot (VOS) holes F and horizontally oriented slot (HOS) holes G;
the field including one column of HOS holes G and at least one parallel column of a plurality of (VOS) holes F; all of the VOS holes F and the HOS holes G being separated from each other by space A, the HOS holes G in the one column of HOS holes G are B=5A wide and H=3A tall;
the VOS holes F are B=2A wide and are L=2H+A=6A+A=7A tall;
the dimensions A, B H, and L of a plate are selected so that a fixture with mounting sites (i.e. fasteners or fastener holes) are sized to match dimension B;
the slotted plate having dimensions B and H that fit dimension B of the bolts and/or screws for mounting fixtures on the slotted plate;
b) placing a fixture on the slotted plate with the fixture having mounting sites with either fasteners or fastener holes with sizes which match dimension B of the slotted plate;
c) sliding and/or rotating the fixture(s) sideways or up and down across the surface of the slotted plate to position all mounting sites of the fixture(s) in to alignment with the VOS holes F and/or HOS holes G in the slotted plate;
d) then fastening the fixture to the slotted plate at all of the mounting sites of the fixture.

2. The method of claim 1 wherein after step d performing the step as follows:
e) clamping the slotted plate to a support structure.

3. The method of claim 2 wherein the clamping step e is performed with an obliquely-sloped, recessed end clamp foot secured to the flange of a support beam.

4. The method of claim 1 wherein another slotted plate is secured to the slotted plate with a connector clamp foot.

5. The method of claim 3 wherein another slotted plate is secured to the slotted plate with a connector clamp foot.

6. The method of claim 3 wherein the end clamp foot includes a horizontal, flat ball on the bottom, an oblique sloped bar reaching up at an oblique angle from a closed joint of the flat ball to a joint with a flat ankle top which extends horizontally formed on the top end of the oblique sloped bar so say that the oblique sloped bar extends at an oblique angle to connect the closed joint of the horizontal, flat ball of the end clamp foot reaching up to the joint of the flat ankle top.

7. The method of claim 6 wherein the horizontal ball is connected to the lower end of the oblique sloped bar, an outer end of the end clamp foot is joined to an inner end of a segmented arch which has a flat top and an outer end comprising a heel so that the segmented arch has a horizontal flat top parallel with the ankle top and an outer end which is the heel of the arch

8. The method of claim 7 wherein the flat top extends parallel to the flat ankle top as well as the flat ball, the bottom edge of the heel is coplanar with the flat ball.

9. The method of claim 8 wherein the ball flat includes a threaded through hole, the flat ankle top includes a threaded through hole.

10. The method of claim 9 wherein directly below the flat ankle top is the segmented arch with a threaded through hole which is directly aligned with and above the threaded through hole in the flat ankle top.

11. The method of claim 10 wherein the end clamp foot is employed to secure the slotted plate to a beam flange.

12. A suspension structure for suspending a slotted plate from a structural support comprising:
a slotted plate including a field with a plurality of columns of vertically oriented, stacked racetrack oval slots spaced apart horizontally;
a column of horizontally oriented racetrack oval slots stacked vertically; and
a clamp with fastening threaded fasteners extending through peripheral slots through the slotted plate for securing the slotted plate to the clamp to a structural support.

13. The suspension structure of claim 12 wherein:
each vertically oriented slot is B=2A wide and 7A tall;
the vertically oriented racetrack oval slots are spaced horizontally by width A;
each of the horizontally oriented racetrack oval slots has a width of C=2A and a height of 7A; and
the horizontally oriented racetrack oval slots are spaced vertically by space A.

14. The suspension structure of claim 12 wherein;
the clamp is fastened to the structural support; and
the clamp is fastened to the slotted plate.

15. The suspension structure of claim 12 wherein the clamp comprises:
a recessed, end clamp foot;
the end clamp foot includes a horizontal, flat ball on the bottom, an obliquely-sloped bar reaching up at an oblique angle from a closed joint with the flat ball;
the obliquely-sloped bar forming a joint on the top end of the oblique sloped bar with a flat ankle top which extends horizontally;
an outer end of the end clamp foot being joined to an inner end of a segmented arch which has a flat top and an outer end ending in a heel;
the segmented arch having a horizontal flat arch top parallel with the flat ankle top and the flat ball; and
the bottom edge of the heel being coplanar with the flat ball.

16. The suspension structure of claim 15 wherein:
each vertically oriented racetrack oval slot is B=2A wide and 7A tall;
the vertically oriented racetrack oval slots spaced apart horizontally by a width of A;
each of the horizontally oriented racetrack oval slots has a width of C=2A and a height of 7A; and
the horizontally oriented racetrack oval slots are spaced apart vertically by a space of A.

17. The suspension structure of claim 15 wherein;
the clamp is fastened to the structural support; and
the clamp is fastened to the slotted plate.

18. The suspension structure of claim 15 wherein:
the flat ball includes a first threaded through hole;
the flat ankle top includes a second threaded through hole; and
the segmented arch includes a third threaded through hole directly aligned with and below the second threaded through hole.

19. The suspension structure of claim 18 wherein:
the flat ball includes a first threaded through hole;
the flat ankle top includes a second threaded through hole; and
the segmented arch includes a third threaded through hole directly aligned with and below the second threaded through hole;
the flat ball includes a first threaded through hole;
the flat ankle top includes a second threaded through hole; and
the segmented arch includes a third threaded through hole directly aligned with and below the second threaded through hole.

20. The suspension structure of claim 12 wherein the field of the slotted plate includes as follows:
three parallel columns of three vertically oriented racetrack oval slots spaced apart horizontally; and
a single column of six horizontally oriented racetrack oval slots.
